(19) United States
(12) Patent Application Publication
(10) Pub. No.: US 2025/0243073 A1
(43) Pub. Date: Jul. 31, 2025

(54) MANIPULATION OF SODIUM SILICATE RATIO ON METAL REMOVAL BY ULTRAFILTRATION AND ULTRAFILTERED BIOGENIC SILICATE PURIFICATION

(71) Applicant: PQ LLC, Malvern, PA (US)

(72) Inventors: Flavio Ernesto Ribeiro, Plainfield, IL (US); Steven Kolb, Lockport, IL (US)

(21) Appl. No.: 18/423,855

(22) Filed: Jan. 26, 2024

(51) Int. Cl. C01B 33/32; B01D 61/14; B01D 69/08

(52) U.S. Cl. CPC C01B 33/325; B01D 61/145; B01D 69/08; C01P 2006/80

(57) ABSTRACT

Embodiments relate to methods for producing a high purity sodium silicate. The present application relates to a distinct pattern in elemental removal of various sodium silicate solutions, as sodium silicate solutions prepared at high SiO₂ to Na₂O mass ratios display better elemental removal than sodium silicate solutions prepared at low SiO₂ to Na₂O mass ratios. Methods therefore include at least (a) providing a biogenic silica; (b) adding the biogenic silica to a first solution (e.g., sodium silicate solution or caustic soda solution); (c) separating undissolved silica form the solution via dissolution to obtain an intermediate solution; and (d) conducting ultrafiltration on the intermediate solution to obtain the high purity sodium silicate.

### FIELD OF THE INVENTION

Embodiments relate to a purification process by manipulating the mass ratio of SiO₂ to Na₂O to generate an ultrapure sodium silicate solution. As the mass ratio of SiO₂ to Na₂O increases, there is a trend towards increased elemental removal after ultrafiltration. The process is therefore achieved by adding silica to increase the ratio and raise complex speciation prior to ultra-filtering through a hollow fiber membrane. Treated biogenic silica may be applied in the process to produce a highly ultrapure biogenic sodium silicate solution.

### BACKGROUND OF THE INVENTION

Sodium silicate solutions are traditionally produced in the chemical industry by the direct fusion of sodium carbonate with a sand source in a furnace at 1,500° C. Various grades of sodium silicate solutions are characterized by their SiO₂ to Na₂O mass ratio. Grades with low ratios are considered alkaline, while grades with high ratios are described as neutral. Sodium silicate solutions at high SiO₂ to Na₂O mass ratios contain more complex silicate speciation existing in a variety of polymeric forms. Low ratio silicates are characterized as having monomeric speciation.

Silica from biogenic sources can be extracted from sources including but not limited to silica accumulating biomaterials such as rice hulls, silica rich tailings, and waste silica-ash by-product from thermoelectric plants. This biogenic silica may require treatment applications to lower impurity levels. Purified biogenic silica can then produce sodium silicate solutions via atmospheric or hydrothermal dissolution with caustic soda at high temperature and pressure using agitation. This process route is advantageous to the traditional furnace route process as it is more sustainable in lowering carbon emissions and lowering the environmental footprint on greenhouse gases. The dissolution of pure silica can prepare sodium silicate solutions at high mass ratios of SiO₂ to Na₂O from 3.5 to 4.0. Applications for raising the ratio of sodium silicate solutions requires the preparation of a stock solution at a high ratio followed by blending the two solutions together.

Sodium silicate has a wide variety of uses including the production of silica gel, adhesives, refractory ceramics, cements, and electronics applications. Among the various applications, sodium silicate elemental purity is important. High levels of impurities can lead to destabilization of sodium silicate solutions by forming polymeric micelles or polysilicates. High impurity levels can also affect the turbidity of the silicate solution presented as a hazy appearance. In the electronics industry for wafer polishing, elements such as Ni, Cr, Cu, and Co cannot exceed concentrations of 50 parts per billion (ppb) in sodium silicate solutions. To maintain low elemental concentrations, high quality silica and soda sources must be selected for stringent applications. To further increase the purity, the use of ultrafiltration on sodium silicate solutions is considered for removing critical metals.

Impurities in sodium silicate can be localized in monomeric and polymeric chains. In ultrafiltration, the hollow fiber membrane rejects a portion of complex polymeric chains while monomeric silicate species pass through creating a permeated product. Ultrafiltration membranes can vary in pore size ranging from 5,000 to 500,000 Daltons. Depending on the solid's concentration of a sodium silicate solution, the membrane pore size for ultrafiltration may be between 100,000 to 500,000 Daltons.

U.S. Pat. No. 9,598,611 describes a process for producing a high purity silica sol by ultrafiltration followed by ion exchange for the removal of the cationic components in the purified aqueous solution. The purified solution is then subjected to an additional ionic exchange process using a chelating ion exchange resin to obtain a high purity silicate solution. The high purity silicate solution (seed solution) is adjusted to an alkaline pH mixed with another high purity solution silicate solution (feed solution) to produce the high purity silica sol having a Cu and Ni concentration (in relation to dry silica) of up to 50 ppb.

U.S. Pat. No. 3,969,266 explains a process for removing water and a salt selected from the group consisting of sodium chloride, sodium carbonate, and sodium sulfate from an aqueous silica sol having a pH from 8 to 11 containing from 1 to 40% by weight of colloidal silica. Soluble salts can be purified by filtering from the sol using a microporous membrane filter while maintaining the salt concentration within a range determined by the concentration of the silica sol.

US Patent Publication No. 2009/0253813 describes a colloidal silica comprising silica particles inside of which or on the surface of which a nitrogen containing alkaline compound is fixed, where silica particles are prepared by forming and growing colloidal particles using nitrogen containing alkaline compound. The colloidal silica is then prepared by preparing an active silicic acid solution contacting the silicate alkali solution with cationic exchange resin. The nitrogen containing alkaline compound is added with heat growing up particles, dissolved in the liquid phase.

US Patent Publication No. 2008/0038996A1 explains a polishing composition for semiconductor wafers containing colloidal silica, prepared from an active silicic acid aqueous solution obtained by removing the from an alkali silicate solution and a quaternary ammonium base. The polishing composition does not contain alkali metals, containing a buffer solution that is a combination of a weak acid having a pKa from 8.0 to 12.5 at 25° C.

### BRIEF SUMMARY OF THE INVENTION

Through ultra-filtering various sodium silicate solutions, it has been discovered that there is a distinct pattern in elemental removal. Sodium silicate solutions prepared at high SiO₂ to Na₂O mass ratios (3.5 to 4.5) were observed with high elemental removal after ultrafiltration. Silicate solutions prepared at lower SiO₂ to Na₂O mass ratios (2.0 to 3.0) were observed with minimal to no removal. It has further been discovered that this phenomenon occurs both with standard furnace sodium silicate solutions and 100% biogenic silicates.

To confirm this finding, a series of experiments were conducted wherein the mass ratio for both furnace sodium silicate and 100% biogenic sodium silicate solutions were progressively increased. Mass ratios from 2.0 to 4.5 were prepared, either using pure biogenic silica extracted from rice hulls to raise the ratio via atmospheric dissolution or causticizing the sodium silicate solution to lower the ratio. After the sodium silicate solutions were prepared, they were subjected to ultrafiltration with temperature and pressure conditions kept constant for all experiments.

The sum of the elemental impurities before and after ultrafiltration were calculated to determine the percent elemental removal of each silicate system organized from lowest to highest mass ratio. A polynomial linear regression was observed, as an increase in the mass ratio of the sodium silicate led to higher elemental removal (see FIG. 1).

In an exemplary method of producing a high purity sodium silicate, the method comprises the steps of providing a biogenic silica; adding the biogenic silica to a sodium silicate solution; separating undissolved silica from the biogenic silica and the sodium silicate solution via dissolution to obtain an intermediate solution; and conducting ultrafiltration of the intermediate solution to obtain the high purity sodium silicate.

In some embodiments, the intermediate solution has a SiO₂ to Na₂O mass ratio between 3.5 to 4.5.

In some embodiments, the biogenic silica has an elemental concentration less than 1000 ppm.

In some embodiments, the step of conducting ultrafiltration comprises conducting ultrafiltration with a hollow fiber membrane.

In some embodiments, the high purity sodium silicate has an elemental concentration between 20-120 ppm.

In some embodiments, a concentration of solids in the intermediate solution is between 20% and 22%.

In some embodiments, the biogenic silica is from a source selected from the group consisting of rice husks, silica rich iron ore tailings, and waste silica by-product from a thermoelectric plant.

In some embodiments, the method further comprises a step of adding a second biogenic silica to the intermediate solution before conducting ultrafiltration of the intermediate solution.

In an exemplary method of producing a high purity sodium silicate, the method comprises the steps of providing a biogenic silica; adding the biogenic silica to a caustic soda solution; separating undissolved silica from the biogenic silica and the caustic soda solution via dissolution to obtain an intermediate solution; and conducting ultrafiltration of the intermediate solution to obtain the high purity sodium silicate.

In some embodiments, the intermediate solution has a SiO₂ to Na₂O mass ratio between 3.5 to 4.5.

In some embodiments, the biogenic silica has an elemental concentration less than 1000 ppm.

In some embodiments, the step of conducting ultrafiltration comprises conducting ultrafiltration with a hollow fiber membrane.

In some embodiments, the high purity sodium silicate has an elemental concentration between 20-120 ppm.

In some embodiments, a concentration of solids in the intermediate solution is between 20% and 22%.

In some embodiments, the biogenic silica is from a source selected from the group consisting of rice husks, silica rich iron ore tailings, and waste silica by-product from a thermoelectric plant.

In some embodiments, the method further comprises a step of adding a second biogenic silica to the intermediate solution before conducting ultrafiltration of the intermediate solution.

In an exemplary method of producing a high purity sodium silicate, the method comprises the steps of providing a biogenic silica; adding the biogenic silica to a silicate glass, wherein the silicate glass has a low mass ratio of SiO₂ to Na₂O; separating undissolved silica from the biogenic silica and the silicate glass via dissolution to obtain an intermediate solution; and conducting ultrafiltration of the intermediate solution to obtain the high purity sodium silicate.

In some embodiments, the biogenic silica is from a source selected from the group consisting of rice husks, silica rich iron ore tailings, and waste silica by-product from a thermoelectric plant.

In some embodiments, the method further comprises a step of: adding a second biogenic silica to the intermediate solution before conducting ultrafiltration of the intermediate solution.

In some embodiments, the silicate glass has a mass ratio of SiO₂ to Na₂O between 2.5 and 2.8.

Further features, aspects, objects, advantages, and possible applications of the present invention will become apparent from a study of the exemplary embodiments and examples described below, in combination with the Figures, and the appended claims.

### BRIEF DESCRIPTION OF THE FIGURES

The above and other objects, aspects, features, advantages, and possible applications of the present invention will be more apparent from the following more particular description thereof, presented in conjunction with the following drawings. It should be understood that like reference numbers used in the drawings may identify like components.

FIG. 1 is a graph showing total elemental removal vs. silicate ratio.

FIG. 2 is a graph showing total metal removal vs. silicate ratio.

FIG. 3 shows an exemplary purification process (from left to right) of an ultra-filtered sodium silicate solution produced from waste silica by-product of the thermoelectric plant.

### DETAILED DESCRIPTION OF THE INVENTION

The following description is of an embodiment presently contemplated for carrying out the present invention. This description is not to be taken in a limiting sense but is made merely for the purpose of describing the general principles and features of the present invention. The scope of the present invention should be determined with reference to the claims.

Embodiments relate to methods for producing high purity sodium silicate. It is readily understood that as the SiO₂ to Na₂O mass ratio of the sodium silicate increases, there is an increase in the complexity of polymeric silicate species. The complexity of the polymeric silicate speciation is the highest in the 4.5 ratio. The 2.0 ratio is composed mostly of monomeric silicate species, with little to no polymeric speciation. It has been found that the highest elemental removal is observed in the highest ratio silicate, where the lowest ratio has minimal to no removal. In particular, as the complexity of the silicate speciation increases, the more elements that are captured in the polymeric chains.

In ultrafiltration, a hollow fiber membrane rejects a portion of complex polymeric chains and allows monomeric silicate species to pass through, thus creating a permeated product. As the SiO₂ to Na₂O mass ratio of the sodium silicate solution increases, the more polymeric species that are rejected from the permeate, thus removing more elements. Silicate solutions prepared at high SiO₂ to Na₂O mass ratios prior to ultrafiltration will therefore produce an overall purer product.

In an exemplary embodiment, a method for producing high purity sodium silicate comprises providing a biogenic silica; adding the biogenic silica to a sodium silicate solution (e.g., 1 part of biogenic silica to 14 parts of an existing sodium silicate solution, such as a standard furnace sodium silicate solution) and optionally water via a dissolution process to obtain an intermediate solution, wherein the intermediate solution is an aqueous portion separated from undissolved silica; and conducting ultrafiltration of the intermediate solution to obtain a permeate (e.g., high purity sodium silicate).

In an alternative embodiment, a method for producing high purity sodium silicate comprises providing a biogenic silica; adding the biogenic silica to a caustic soda solution (e.g., 1.6 parts of biogenic silica to 1 part of caustic soda) and optionally water via a dissolution process to obtain an intermediate solution, wherein the intermediate solution is an aqueous portion separated from undissolved silica; and conducting ultrafiltration of the intermediate solution to obtain a permeate (e.g., high purity sodium silicate).

In another embodiment, a method for producing a pure sodium silicate comprises providing a waste biogenic silica from a thermoelectric plant; adding the waste biogenic silica to a caustic soda solution (e.g., 2.06 parts of waste biogenic silica to 1 part of caustic soda solution) and optionally water via a dissolution process to obtain an intermediate solution. It is contemplated that the dissolution process may allow undissolved silica containing carbon to settle and separate from an aqueous portion to obtain the intermediate solution, wherein the intermediate solution is an aqueous portion separated from undissolved silica. The method further comprises conducting ultrafiltration of the intermediate solution to obtain a permeate (e.g., high purity sodium silicate).

In an alternative embodiment, a method for producing a pure sodium silicate comprises providing silica rich iron ore tailings; adding the waste iron ore tailings to caustic soda solution (e.g., 2.17 parts of iron ore tailings to 1 part of caustic soda solution) and optionally water via a dissolution process to obtain an intermediate solution (e.g., the intermediate solution is an aqueous portion separated from undissolved silica); followed by providing a biogenic silica; adding the biogenic silica to the intermediate solution via a dissolution process to increase the mass ratio of the intermediate solution; and conducting ultrafiltration of the intermediate solution to obtain a permeate (e.g., high purity sodium silicate). It is contemplated that the added biogenic silica may be from a different source than the silica rich iron ore tailings.

In an additional embodiment, a method for producing a pure sodium silicate comprises providing low ratio silicate glass (e.g., 2.5 to 2.8 mass ratio) and a first biogenic silica; adding the biogenic silica to the low ratio silicate glass (e.g., 1 part of biogenic silica to 10.29 parts of low ratio silicate glass) and optionally water via a dissolution process to obtain an intermediate solution, wherein the intermediate solution is an aqueous portion separated from undissolved silica; followed by adding a second biogenic silica to the intermediate solution via a dissolution process to increase the mass ratio of the intermediate solution; and conducting ultrafiltration of the intermediate solution to obtain a permeate (e.g., high purity sodium silicate). In this embodiment, it is contemplated that the source of the first biogenic silica may be the same as or different than the source of the second biogenic silica.

The biogenic silica of the described embodiments may be a pure biogenic silica and may have an elemental concentration less than 1000 ppm, preferably less than 800 ppm, most preferably less than 600 ppm. The biogenic silica may further have a free humidity of less than 3%, preferably less than 1%, most preferably less than 0.5%. The carbon concentration of the biogenic silica may be between 0.1 and 1.5%, preferably between 0.1 and 0.5%, and is most preferably 0.1%. It is contemplated that the biogenic silica may be derived from any suitable source, including but not limited to rice husks, silica rich iron ore tailings, and waste silica by-product via combustion process of rice husks to power thermoelectric plants, and combinations thereof. It is contemplated that the biogenic silica may first need to be treated to lower its elemental concentration.

The dissolution processes of the described embodiments may be atmospheric dissolution or hydrothermal dissolution. It is contemplated that a dissolution process may be performed under high temperatures, such as between 55-85° C., preferably between 55-70° C., most preferably between 60-65° C. It is further contemplated that the dissolution process may be performed under controlled agitation for 1.5 to 2 hours. The intermediate solution obtained from the dissolution process is between 20-22%, preferably between 20-21%, most preferably 20-20.5% solids concentration (sum of the mass % Na₂O and % SiO₂), as any higher concentration can dramatically reduce ultrafiltration rates.

In a preferred embodiment, the intermediate solution should be prepared between a 3.5-4.5, preferably between a 3.8-4.2, most preferably between a 3.9-4.0, SiO₂ to Na₂O mass ratio prior to ultrafiltration, as permeate rates are significantly reduced towards a 4.5 SiO₂ to Na₂O mass ratio.

The ultrafiltration process may be performed with a hollow fiber membrane. In a preferred embodiment, the pore size in the hollow fiber membrane should range from 400,000 to 600,000 Daltons, preferably 450,000 to 550,000, most preferably 500,000 Daltons. It is contemplated that the ultrafiltration process may be performed at a temperature of 30-60° C., preferably 50-55° C., most preferably 53-55° C. As the rate of permeation decreases at lower temperatures, and a constant transmembrane pressure between the range of 20-30 psi, preferably 25-30 psi, most preferably 28-30 psi must be maintained during the ultrafiltration process. The high purity sodium silicate permeate may be collected after ultrafiltration and stored in a collection tank.

The high purity sodium silicate permeate may have an overall elemental concentration of 20-120 ppm, which is more than four times lower than the elemental concentration of a standard furnace sodium silicate solution. Accordingly, it is contemplated that providing a product with this elemental purity would be advantageous for various markets. Those skilled in the art would find many potential uses for the product, such as feedstock for the colloidal silica market and as nanoparticles in the electronics market for wafer polishing.

Colloidal silica manufacturers typically produce nanoparticles for a wide range of markets: papermaking, foundry/refractory, catalysts and electronics polishing; typically, all use the same grade of silicate for all applications. As the requirements in the electronics market become more stringent, it is clear that a higher quality, more consistent product is required for electronics where the other markets can use the current commercial grade silicate.

The colloidal market for electronics would benefit from a silicate that has a low metal impurity level, a small standard deviation of the significant metals for their electronic customers and an effective performance on their high purity cleaning process for electronics specs.

### EXAMPLES

To confirm the finding that sodium silicate solutions prepared at high ratios correlate to high elemental removal, a series of experiments were conducted.

### Experiment 1

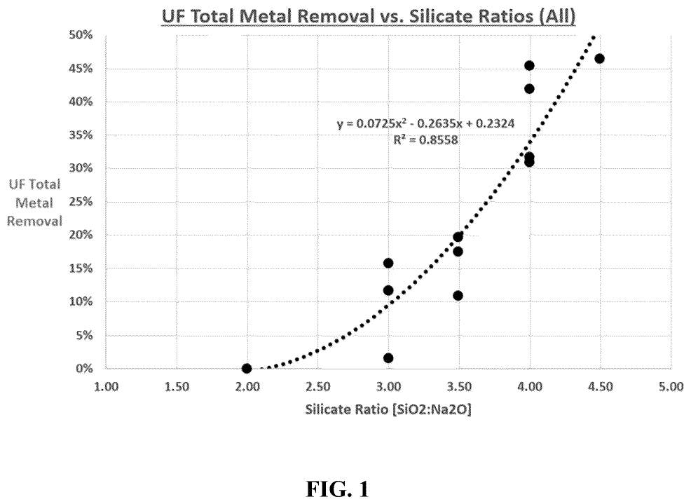

Of the manipulated furnace and biogenic silicates prepared from mass ratios of 2.0 to 4.5, before and after ultra-filtering samples were prepared by extracting 2 grams of the sodium silicate solution diluted with 96 mL of ultrapure water, followed by the addition of 2 mL of nitric acid to dissolve the silicate solution. The prepared samples were then subjected to ICP-MS analysis to scan the sum of the elements before and after ultra-filtering. To calculate the percent elemental removal of each silicate system, elemental concentrations for the as is SiO₂ values were expressed as 100% SiO₂ to accurately reflect the removal of each element since the percent SiO₂ concentration decreases after ultrafiltration. The results of the experiment are shown in FIG. 1.

FIG. 1 shows an increase in polynomial regression (as the sodium silicate ratio increases, the total elemental removal increases). There is a 85.58% correlation to this relationship of increasing the ratio to increasing the total elemental removal of impurities.

At a mass ratio of 2.0, there was 0% of total elemental removal; as the ratio increases towards 3.5, elemental removal can range from 11 to 20%. As the ratio approaches to a 4.0, we observed total elemental removal in the range 31 to 45%. The highest elemental removal observed was at a mass ratio of 4.5, removing up to 46.4% total impurities.

As the ratio of the sodium silicate solution increases, the more polymeric species that are rejected from the permeate, thus removing more elements. Silicate solutions prepared at high ratios prior to ultrafiltration will produce an overall purer product, thus having higher elemental removal of impurities. FIG. 1 consists of furnace silicates manipulated to higher ratios with pure biogenic silica and hydrogel silica; in addition to 100% biogenic silicate systems (causticized biogenic silica via atmospheric dissolution).

### Experiment 2

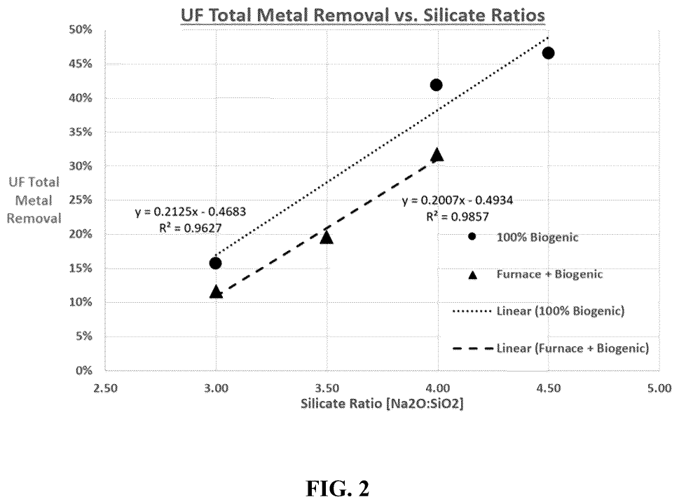

Two sodium silicate systems were compared for the relationship of mass ratio to metal removal. Standard furnace silicate mass ratio was manipulated with biogenic silica to prepare 3.5 and 4.0 mass ratio systems. The 3.0 mass ratio system was prepared by adding caustic soda to lower the mass ratio (originally 3.22). 100% biogenic sodium silicate prepared at mass ratios ranging from 3.0 to 4.5. Sample processing was the same to the steps carried out in Experiment 1. The results of the experiment are shown in FIG. 2.

FIG. 2 shows higher total elemental removal associated to the 100% biogenic silicate system as the mass ratio increases. At a mass ratio of 4.0, the total elemental removal was observed at 41.8% for the 100% biogenic silicate system, where the manipulated furnace silicate at the same ratio was observed for total elemental removal at 31.6%.

The regression analysis for both silicate systems in FIG. 2 display a linear relationship, with a higher slope in the 100% biogenic silicate system. Overall, the 100% biogenic silicate system is higher in total elemental removal at each observed ratio compared the furnace silicate system.

The elemental removal of the 100% biogenic silicate system is higher than the manipulated furnace silicate system perhaps due to differences in the starting elemental concentration prior to ultrafiltration. 100% biogenic silicate has a much lower level of impurities than the furnace silicate, which may allow for better ultrafiltration abilities due to less impurities overwhelming the hollow fiber membrane.

Elemental removal is higher in the 100% biogenic system than the furnace silicate system from possible speciation differences. There may be more elements localized in complex polymeric chains of the 100% biogenic silicate whereas there may be less elements retained in the polymeric chains of the furnace silicate system. There is a possibility more impurities are passing through the hollow fiber membrane within the monomeric speciation of the furnace silicate system.

Table 1 displays ultra-filtered sodium silicate product profiles. Much lower elemental concentrations are observed with the 100% biogenic silicate systems. The lowest total elemental concentration received was 24.46 ppm, ultra-filtered at a 4.5 mass ratio for the 100% biogenic silicate system. A finding of the 100% biogenic silicate systems is the low Al concentrations. We were able to reduce the Al ppm from 2.31 to 0.67 as we increased the mass ratio from 2.0 to 4.5. This is considerably much lower than the furnace silicate systems.

TABLE 1

| | Silicate Type | | | | | | |
|---|---|---|---|---|---|---|---|
| | 100% Biogenic Silicate | | | | Furnace Silicate Boosted | | |
| | Ratio | | | | | | |
| | 2.00 | 3.00 | 4.00 | 4.50 | 3.00 | 3.50 | 4.00 |
| Percent Removed | 0.00% | 15.72% | 41.80% | 46.38% | 11.57% | 19.51% | 31.64% |
| UF Product Yield (ppm) | 62.42 | 52.94 | 30.52 | 24.46 | 82.14 | 56.34 | 32.8 |
| Al Yield (ppm) | 2.31 | 1.78 | 1.3 | 0.67 | 52.31 | 28.04 | 2.39 |
| Titanium Yield (ppb) | 17 | 13 | 8.82 | 27 | 4397 | 2060 | 104 |
| Cobalt Yield (ppb) | 4.02 | 2.93 | 0.52 | 0.48 | 1.41 | 1.66 | 2.55 |
| Nickel Yield (ppb) | 99 | 54.42 | 17.71 | 6.92 | 3.1 | 19.1 | 16.87 |
| Copper Yield (ppb) | 526 | 332 | 77 | 74 | 12 | 118 | 145 |
| Zinc Yield (ppb) | 587 | 509 | 327 | 36 | 114 | 200 | 296 |

An interesting finding is the effect pure biogenic silica has on the Al concentration for the 4.0 ratio furnace silicate for table 1. We observe a decrease in the Al concentration from 52.31 to 2.39 ppm as the ratio is increased from 3.0 to 4.0. The application of adding pure biogenic silica to increase the ratio of a furnace silicate prior to ultrafiltration.

The experiments above demonstrate that the manipulation of sodium silicate mass ratio before ultrafiltration can be used to lower elemental impurities. We determined that 100% biogenic silicate system have overall better elemental removal than manipulated furnace silicate systems; however, the application to use pure biogenic silica should be considered in the industrial applications of existing furnace silicates the elemental impurities were greatly reduced.

### Experiment 3

To confirm the finding that waste silica by-product from thermoelectric plants can be used as a biogenic source to generate a pure sodium silicate, a series of experiments were conducted.

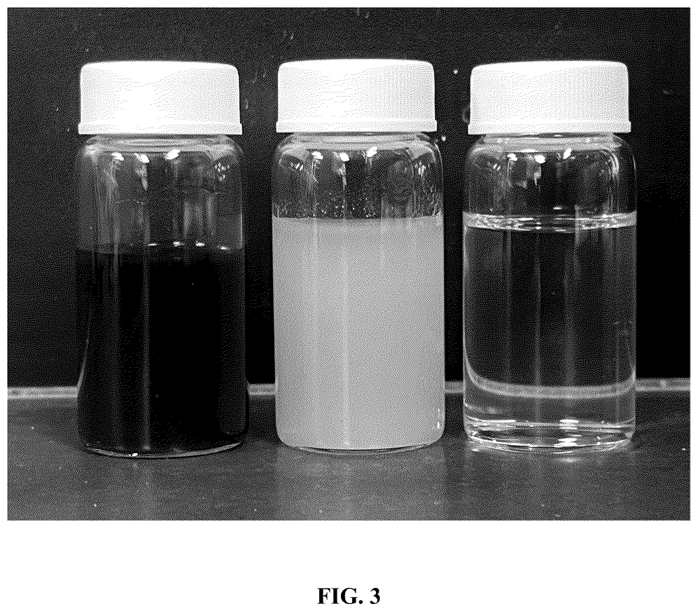

Waste silica-ash generated as a by-product from a thermoelectric combustion process of rice husks was used to prepare a 4.0 mass ratio, 28% solids sodium silicate solution via atmospheric dissolution process. After one day of producing a sodium silicate solution from the waste silica, the carbon containing silica settled by gravity from aqueous portion of the sodium silicate. The aqueous portion was used as the intermediate product with a solids concentration of 22% followed by ultrafiltration to generate a stable sodium silicate with a low metal profile and low turbidity (see FIG. 3).

Turbidity samples were extracted on the day of production, one day after production to collect the aqueous portion of the sodium silicate, and after ultrafiltration. The aqueous portion of the sodium silicate was sampled prior to ultrafiltration by extracting 2 grams of the sodium silicate solution diluted with 96 mL of ultrapure water, followed by the addition of 2 mL of nitric acid to dissolve the silicate solution. The permeate was also sampled by the previously described process. The prepared samples were then subjected to ICP-MS analysis to scan the sum of the elements before and after ultra-filtering. To calculate the percent removal of each element, elemental concentrations for the as is SiO₂ values were expressed as 100% SiO₂ to accurately reflect the removal of each element since the percent SiO₂ concentration decreases after ultrafiltration. The turbidity results of the experiment are shown in FIG. 3 and Table 2 displays the elemental profiles the intermediate and ultra-filtered sodium silicate profile displaying percent removal expressed at 100% SiO₂.

TABLE 2

| | | | Percent |
|---|---|---|---|
| Element (ppb) | Intermediate | Permeate | Removed |
| B | 6452 | 5152 | 0.00% |
| Mg | 228599 | 5330 | 96.81% |
| Al | 60525 | 34854 | 21.11% |
| K | 2975338 | 2157536 | 0.65% |
| Ca | 517246 | 19165 | 94.92% |
| Ti | 1942 | 379 | 73.29% |
| V | 99 | 82 | 0.00% |
| Cr | 12 | 0 | 100.00% |
| Mn | 439533 | 7309 | 97.72% |
| Fe | 43202 | 728 | 97.69% |
| Co | 325 | 6.84 | 97.12% |
| Ni | 64 | 1.94 | 95.87% |
| Cu | 205 | 59 | 60.35% |
| Zn | 9777 | 3851 | 46.04% |
| As | 109 | 91 | 0.00% |
| Se | 11 | 0 | 100.00% |
| Zr | 105 | 82 | 0.00% |
| Mo | 104 | 96 | 0.00% |
| Ba | 17783 | 7244 | 44.19% |
| Pb | 14 | 5.92 | 42.75% |
| Total (ppb) | 4301446 | 2241973 | 28.59% |
| Total (ppm) | 4301 | 2242 | |

The ultrafiltration process removed a vast amount of impurities in high concentrations. The intermediate product had a total elemental concentration of 4301 ppm composed of mostly K, Ca, Mn, and Mg. We observed total removal of Cr and Se with over 90% elemental removal in Mg, Ca, Mn, Fe, Co, and Ni, with over 70% removal in Ti. We observed minimal removal of Zn, Ba, and Pb with over 40% reduction. The permeated product had a total concentration of 2242 ppm, primarily composed of K at 2157 ppm with other remaining metals accounting for 85 ppm. Although the concentration of K is high, this monovalent ion may be removed prior, similar to the ionic exchange of Na for colloidal processing.

The permeated product from Table 2 contains very low concentrations of Co, Cu, Ni, and Ti; which is advantageous for the colloidal market for electronics. The experiment above demonstrates that waste silica from thermoelectric plants can potentially be used as a source to generate an intermediate feed sodium silicate for ultrafiltration, and then purified to remove most of the impurities.

### Experiment 4

To confirm the finding that silica rich iron ore tailings can be used as a biogenic source to generate a pure sodium silicate solution, a series of experiments were conducted.

Silica rich iron ore tailings originated as a by-product from the mining industry were used to initially prepare an alkaline 2.4 mass ratio sodium silicate via hydrothermal dissolution process followed by raising the mass ratio to 4.0 with pure biogenic silica via a atmospheric dissolution process at 20% solids concentration. The intermediate sodium silicate solution was subjected to ultrafiltration to generate an ultrapure sodium silicate solution removing most impurities.

Before and after ultra-filtering samples were prepared by extracting 2 grams of the sodium silicate solution diluted with 96 mL of ultrapure water, followed by the addition of 2 mL of nitric acid to dissolve the silicate solution. The prepared samples were then subjected to ICP-MS analysis to scan the sum of the elements before and after ultra-filtering. To calculate the percent removal of each element, elemental concentrations for the as is SiO₂ values were expressed as 100% SiO₂ to accurately reflect the removal of each element since the percent SiO₂ concentration decreases after ultrafiltration. The results of the experiment are shown in Table 3.

TABLE 3

| Element | | | Percent |
|---|---|---|---|
| (ppb) | Intermediate | Permeate | Removed |
| B | 694 | 619 | 0.00% |
| Mg | 7924 | 170 | 97.26% |
| Al | 188735 | 71379 | 51.77% |
| K | 10875 | 8513 | 0.18% |
| Ca | 5844 | 1630 | 64.42% |
| Ti | 254 | 85 | 57.23% |
| V | 144 | 159 | 0.00% |
| Cr | 554 | 185 | 57.45% |
| Mn | 11341 | 2154 | 75.78% |
| Fe | 64144 | 16563 | 67.07% |
| Co | 36 | 1.55 | 94.58% |
| Ni | 249 | 7.77 | 96.01% |
| Cu | 410 | 53 | 83.46% |
| Zn | 451 | 188 | 46.84% |
| As | 179 | 222 | 0.00% |
| Se | 61 | 9.18 | 80.88% |
| Zr | 239 | 70 | 62.96% |
| Mo | 3429 | 4300 | 0.00% |
| Ba | 986 | 411 | 46.88% |
| Pb | 87 | 47 | 31.57% |
| Total (ppb) | 296638 | 106767 | 54.10% |
| Total (ppm) | 296.64 | 106.77 | |

The permeate contained a total elemental concentration almost three times lower than the elemental concentration of the intermediate solution. The total elemental concentration of the intermediate solution was 296.64 ppm with Al at 188.74 ppm and Fe at 64.14 ppm. After ultrafiltration, the total elemental concentration was reduced to 106.77 ppm, lowering Al to 71.38 ppm and Fe to 16.56 ppm. We observed over 90% removal of Mg, Co, and Ni with over 80% removal of Cu and Se; and over 60% removal of Ca, Mn, Fe, and Zr. More than 50% removal occurred among Al, Ti, and Cr. With ratio manipulation to 4.0, we were able to achieve a total elemental removal at 54.10%.

The experiment above demonstrates that silica rich iron ore tailings can be used as a biogenic source for producing an intermediate sodium silicate solution for ultrafiltration as most of the Fe and Al derived from the iron ore tailing can be removed during the purification process. The permeate generated in Table 3 contains very low concentrations of Co, Cu, Mg, Ni, Se, and Ti; which could be beneficial raw material for colloidal processing for electronics.

### Experiment 5

To confirm the finding that pure biogenic silica can be used to manipulate the ratio of low ratio sodium silicate glass to produce an intermediate sodium silicate solution prior to ultrafiltration, a series of experiments were conducted.

An alternative process route using low ratio sodium silicate glass and pure biogenic silica were used to prepare a 3.3 mass ratio sodium silicate solution via hydrothermal dissolution process followed by raising the mass ratio to 4.0 via atmospheric dissolution process with pure biogenic silica to create an intermediate sodium silicate solution at 20% solids concentration. The intermediate sodium silicate solution was subjected to ultrafiltration to generate an ultrapure sodium silicate solution.

The intermediate and permeate sodium silicate solution were prepared by extracting 2 grams of the sodium silicate solution diluted with 96 mL of ultrapure water, followed by the addition of 2 mL of nitric acid to dissolve the silicate solution. The prepared samples were then subjected to ICP-MS analysis to scan the sum of the elements before and after ultra-filtering. To calculate the percent removal of each element, elemental concentrations for the as is SiO₂ values were expressed as 100% SiO₂ to accurately reflect the removal of each element since the percent SiO₂ concentration decreases after ultrafiltration. The results of the experiment are shown in Table 4.

TABLE 4

| Element | | | Percent |
|---|---|---|---|
| (ppb) | Intermediate | Permeate | Removed |
| B | 1945 | 1854 | 0.00% |
| Mg | 3929 | 368 | 88.26% |
| Al | 64524 | 25691 | 50.09% |
| K | 5239 | 4123 | 1.36% |
| Ca | 9928 | 3989 | 49.64% |
| Ti | 13647 | 4716 | 56.69% |
| V | 50 | 56 | 0.00% |
| Cr | 337 | 137 | 48.91% |
| Mn | 2546 | 763 | 62.45% |
| Fe | 14211 | 4520 | 60.14% |
| Co | 7.78 | 2.20 | 64.62% |
| Ni | 142 | 2.96 | 97.39% |
| Cu | 274 | 53 | 75.98% |
| Zn | 323 | 141 | 45.22% |
| As | 41 | 46 | 0.00% |
| Se | 57 | 4.88 | 89.33% |
| Zr | 8412 | 2285 | 65.95% |
| Mo | 234 | 283 | 0.00% |
| Ba | 750 | 387 | 35.25% |
| Pb | 82 | 45 | 31.81% |
| Total (ppb) | 126681 | 49468 | 51.06% |
| Total (ppm) | 126.68 | 49.47 | |

The ultrafiltration process removed most impurities lowering the total elemental concentration more than two-fold from 126.68 ppm to 49.47 ppm. We observed very high removal of Cu, Mg, Ni, and Se with Al reducing from 64.52 to 25.69 ppm and Ti reducing from 13.65 to 4.72 ppm. The permeate contained very low levels of Ni and Co below 3 ppb followed by Se at 4.88 ppb. The total elemental concentration of this experiment is slightly higher than a manipulated furnace silicate at the same ratio; however, this process route of dissolving sodium silicate glass with pure biogenic silica via hydrothermally can be achieved if the ratio intermediate solution is manipulated. The permeate possesses a low metal profile advantageous to the electronics market for colloidal processing.

Although the description above contains specificities of the technology, they should not be interpreted as limitations to the scope of this invention, but as an example of a preferred embodiment. The scope of the present invention must be determined by the embodiments illustrated, but with the set of claims and its legal equivalents.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the apparatus and methods of using and making the same disclosed herein have been discussed and illustrated, it is to be distinctly understood that the invention is not limited thereto but may be otherwise variously embodied and practiced within the scope of the following claims.

What is claimed is:

1. A method for producing a high purity sodium silicate, comprising the steps of:
a. providing a biogenic silica;
b. adding the biogenic silica to a sodium silicate solution;
c. separating undissolved silica from the biogenic silica and the sodium silicate solution via dissolution to obtain an intermediate solution; and
d. conducting ultrafiltration of the intermediate solution to obtain the high purity sodium silicate.

2. The method of claim 1, wherein the intermediate solution has a SiO₂ to Na₂O mass ratio between 3.5 to 4.5.

3. The method of claim 1, wherein the biogenic silica has an elemental concentration less than 1000 ppm.

4. The method of claim 1, wherein the step of conducting ultrafiltration comprises conducting ultrafiltration with a hollow fiber membrane.

5. The method of claim 1, wherein the high purity sodium silicate has an elemental concentration between 20-120 ppm.

6. The method of claim 1, wherein a concentration of solids in the intermediate solution is between 20% and 22%.

7. The method of claim 1, wherein the biogenic silica is from a source selected from the group consisting of rice husks, silica rich iron ore tailings, and waste silica by-product from a thermoelectric plant.

8. The method of claim 1, further comprising:
e. adding a second biogenic silica to the intermediate solution before conducting ultrafiltration of the intermediate solution.

9. A method for producing a high purity sodium silicate comprising:
a. providing a biogenic silica;
b. adding the biogenic silica to a caustic soda solution;
c. separating undissolved silica from the biogenic silica and the caustic soda solution via dissolution to obtain an intermediate solution; and
d. conducting ultrafiltration of the intermediate solution to obtain the high purity sodium silicate.

10. The method of claim 9, wherein the intermediate solution has a SiO₂ to Na₂O mass ratio between 3.5 to 4.5.

11. The method of claim 9, wherein the biogenic silica has an elemental concentration less than 1000 ppm.

12. The method of claim 9, wherein the step of conducting ultrafiltration comprises conducting ultrafiltration with a hollow fiber membrane.

13. The method of claim 9, wherein the high purity sodium silicate has an elemental concentration between 20-120 ppm.

14. The method of claim 9, wherein a concentration of solids in the intermediate solution is between 20% and 22%.

15. The method of claim 9, wherein the biogenic silica is from a source selected from the group consisting of rice husks, silica rich iron ore tailings, and waste silica by-product from a thermoelectric plant.

16. The method of claim 9, further comprising:
e. adding a second biogenic silica to the intermediate solution before conducting ultrafiltration of the intermediate solution.

17. A method for producing a high purity sodium silicate comprising:
a. providing a biogenic silica;
b. adding the biogenic silica to a silicate glass, wherein the silicate glass has a low mass ratio of SiO₂ to Na₂O;
c. separating undissolved silica from the biogenic silica and the silicate glass via dissolution to obtain an intermediate solution; and
d. conducting ultrafiltration of the intermediate solution to obtain the high purity sodium silicate.

18. The method of claim 17, wherein the biogenic silica is from a source selected from the group consisting of rice husks, silica rich iron ore tailings, and waste silica by-product from a thermoelectric plant.

19. The method of claim 17, further comprising:
e. adding a second biogenic silica to the intermediate solution before conducting ultrafiltration of the intermediate solution.

20. The method of claim 17, wherein the silicate glass has a mass ratio of SiO₂ to Na₂O between 2.5 and 2.8.
